(19) United States
(12) Patent Application Publication
(10) Pub. No.: US 2007/0296775 A1
(43) Pub. Date: Dec. 27, 2007

(54) Ink cartridge and ink supplying apparatus of image forming device

(75) Inventors: Young-su Lee, Yongin-si (KR); Myung-song Jung, Gunpo-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/649,215

(22) Filed: Jan. 4, 2007

(30) Foreign Application Priority Data
Jun. 26, 2006 (KR) 2006-57383

(51) Int. Cl. B41J 2/175

(52) U.S. Cl. 347/86

(57) ABSTRACT

An ink cartridge and an ink supplying apparatus of an image forming device, which can prevent a deformation of a needle in an ink cartridge mounting operation, an inflow of external air in a printing operation, and an ink leakage, includes a cartridge body having an ink discharging unit, an inner cap disposed in the ink discharging unit to close or selectively seal the ink discharging unit, and having a needle seating groove formed in a shape corresponding to an end of a needle, and an outer cap disposed outside the ink discharging unit. The inner cap is movable in a direction, which opens or selectively unseals the ink discharging unit, when the needle of a needle assembly is used in a combination with the ink cartridge.

### CROSS-REFERENCE TO RELATED APPLICATION

This application claims the benefit of Korean Application No. 2006-57383, filed Jun. 26, 2006 in the Korean Intellectual Property Office, the disclosure of which is incorporated herein by reference.

### BACKGROUND OF THE INVENTION

1. Field of the Invention

Aspects of the present invention generally relate to an image forming device, and more particularly, to an ink cartridge of an image forming device, such as an inkjet printer, which ejects ink to form an image, and an ink supplying apparatus of the image forming device, which supplies ink of the ink cartridge to a print head.

2. Description of the Related Art

FIG. 1A illustrates a related art ink cartridge 1, which is used in an image forming device (such as an inkjet printer). FIG. 1B illustrates a related art ink supplying apparatus 2 that corresponds to the ink cartridge of FIG. 1A. The ink supplying apparatus 2 supplies ink from the ink cartridge to a print head.

As illustrated in FIG. 1A, the ink cartridge 1 includes a cartridge body 3 containing ink therein, and an ink discharging unit 10 to discharge the ink from the cartridge body 3. The ink discharging unit 10 includes a ball 11, an elastic spring 12 to elastically urge the ball 11, a rubber cap 13, and a metal cap 14.

A slit 13a is formed in the center of the rubber cap 13. The ball 11 is elastically urged by the elastic spring 12 to come in to contact with the slit 13a. Also, in a portion of the metal cap 14 which faces the slit 13a, an opening 14a is formed.

As illustrated in FIG. 1B, the ink supplying apparatus 2 includes a needle assembly 20. The needle assembly 20 is connected with the ink discharging unit 10 of the ink cartridge 1 shown in FIG. 1A to form an ink supplying apparatus to supply the ink to a print head. As shown, the needle assembly 20 includes a needle 21, a needle guide 22, a spring 23, and a housing 24.

As shown in FIG. 1B, the needle 21 has an ink passage (not shown) formed therein, and an ink hole 21a formed at a side of the top of the needle 21 to communicate with the ink passage. When the needle assembly 20 is coupled with the ink cartridge 1, the needle 21 passes through the slit 13a of the rubber cap 13 and pushes up the ball 11 so as to form a passage way for the ink. As shown in FIG. 1B, the needle guide 22 is disposed to be movable up and down in the housing 24, but is elastically urged toward the upside of FIG. 1B by the spring 23.

However, the ink cartridge 1 as described above has a structure that makes the needle 21 contact the ball 11 at a point, a position of the ball 11 where the needle 21 contacts the ball 11 may vary according to a position orientation of the needle 21 after passing through the slit 13a. If the needle 21 contacts the ball 11 but deviates from the center of the ball 11, the needle 21 may slip, be pushed to one side, and be bent while pushing up the ball 11.

Moreover, if the needle 21 becomes bent or deformed, the off axis position of the needle 21 relative to the ball 11 may cause the slit 13a through which the needle 21 passes to gape (or be opened), so that the ink leaks through the gaped slit 13a while a printing operation is temporary stopped. In addition, during a printing operation, external air may flow in through the gaped slit 13a and obstruct the ink from being supplied to the print head.

Also, if the contact of the needle 21 with the ball 11 deviates from the center of the ball 11 as described above, the spring 12 (which elastically urges the ball 11) may be also deformed while being compressed by the ball 11 to one side of the ink discharging unit 100. Accordingly, once the spring 12 is deformed, the deformed spring 12 may push on the ball 11 at an odd angle relative to the slit 13a and cause the ball 11 to not completely close up or press against the slit 13a of the rubber cap 13. As a result, if the ink cartridge is then removed while the ink remains in the ink discharging unit 10, the ink may leak through the slit 13a.

### SUMMARY OF THE INVENTION

An aspect of the present invention includes an ink cartridge and an ink supplying apparatus of an image forming device, which can prevent a needle from being deformed when an ink cartridge is mounted.

Another aspect of the present invention includes an ink cartridge and an ink supplying apparatus of an image forming device, which can not only prevent external air from flowing into the ink cartridge during a printing operation, but also prevent ink contained therein from leaking.

According to an aspect of the present invention, an ink cartridge includes a cartridge body having an ink discharging unit, and an inner cap having a needle seating groove formed in a predetermined shape corresponding to an end of a needed to be inserted into the ink discharging unit, the inner cap being disposed in the ink discharging unit to selectively seal the ink discharging unit, and the inner cap being movable in a direction which selectively unseals the ink discharging unit by the needle.

The ink cartridge may further include an outer cap disposed on the outside of the ink discharging unit, and an elastic member to elastically urge the inner cap in a direction which selectively seals the ink discharging unit.

The inner cap may be formed in the form of disc.

The outer cap may be configured to be penetrated by the needle, and may include a sealing member through which the needle is inserted, and a cover member to support the sealing member to the ink discharging unit. The sealing member may have a guide groove to guide an inserting position of the needle.

The ink cartridge may further include a seal to seal between the inner cap and the sealing member. The seal may be formed on the sealing member or the inner cap. The seal may be formed in an annular shape, so that the seal surrounds a penetrated (or penetrable) hole of the sealing member, which is penetrated by the needle. Also, the seal may be embodied in a plurality of seals.

According to another aspect of the present invention, an ink supplying apparatus includes an ink discharging unit to discharge ink stored in an ink cartridge, an inner cap disposed in the ink discharging unit to selectively seal the ink discharging unit, and a needle assembly having a needle connected with the ink discharging unit and being able to move the inner cap in a direction which selectively unseals the ink discharging unit, so that the needle forms an ink supplying passage. The inner cap includes a needle seating groove formed in a shape corresponding to an end of the needle at a position contacting the needle.

The inner cap may be movable between a first position, which selectively seals the ink discharging unit, and a second position, which unseals the ink discharging unit, and the ink supplying apparatus may further include an elastic member to elastically urge the inner cap to the first position.

The ink supplying apparatus may further include an outer cap connected to the outside of the ink discharging unit, and having an inserting position guide groove, which is initially not penetrated, and which is formed at a position where the outer cap may be penetrated by the needle.

The outer cap may include a sealing member through which the needle is inserted, and a cover member to support the sealing member to the ink discharging unit.

The ink supplying apparatus may further include a seal to seal between the inner cap and the sealing member. The seal may be formed on the sealing member and/or the inner cap. At this time, the seal may be formed in an annular shape, so that the seal surrounds a penetrated (or a penetrable) hole of the sealing member, which is penetrated by the needle. Also, the seal may be embodied in a plurality of seals.

Aspects of the present invention includes an ink discharging part of an ink cartridge for an image forming device including: an internal cavity formed in the ink discharging unit to receive ink, the internal cavity being capped at one end; and an inner cap slidingly positioned inside the internal cavity, the inner cap comprising an indented seating part to receive a needle, and to guide and support the needle as the inner cap slides along the internal cavity.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1A is a cross sectional view schematically illustrating a related art ink cartridge, and FIG. 1B is a cross sectional view schematically illustrating a related art ink supplying apparatus that corresponds to the ink cartridge of FIG. 1A of an image forming device;

FIG. 2 is are a perspective view schematically illustrating an ink cartridge and an ink supplying apparatus of an image forming device according to an aspect of the present invention;

FIG. 3 is an enlarged cross sectional view illustrating a main part of the ink supplying apparatus of FIG. 2;

FIG. 4 is a cross sectional view illustrating the ink supplying apparatus of FIGS. 2 and 3 with an ink discharging unit connected to a needle assembly;

FIGS. 5A, 5B and 5C are perspective views of various modified examples of an inner cap of the ink cartridge according to aspects of the present invention; and

FIGS. 6A, 6B and 6C are perspective views of a modified example of a sealing member forming an outer cap of the ink cartridge according to an aspect of the present invention.

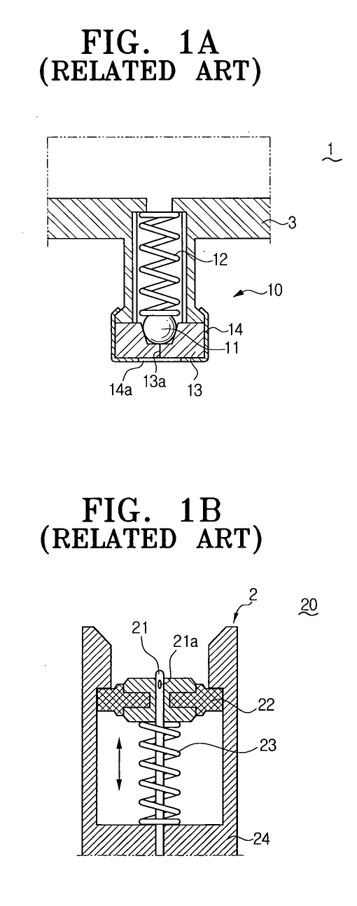

### DETAILED DESCRIPTION OF THE EMBODIMENTS

Reference will now be made in detail to aspects of the present invention, examples of which are illustrated in the accompanying drawings, wherein like reference numerals refer to the like elements throughout. The aspects are described below in order to explain the present invention by referring to the figures.

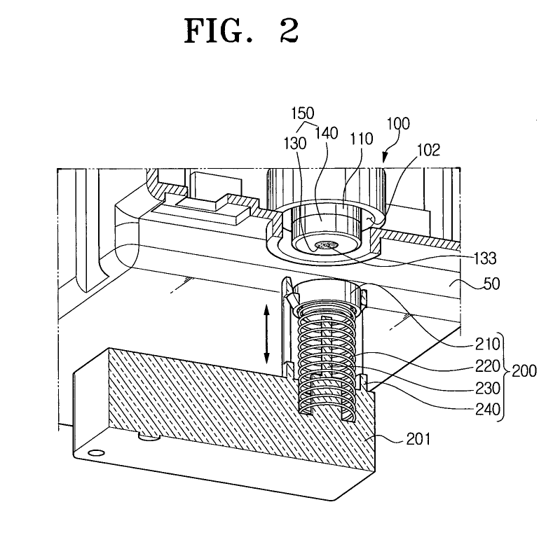

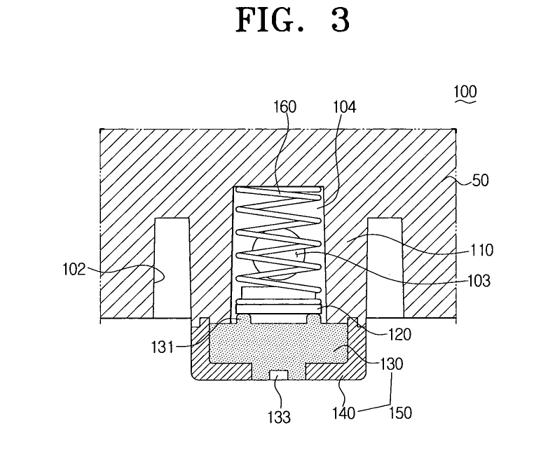

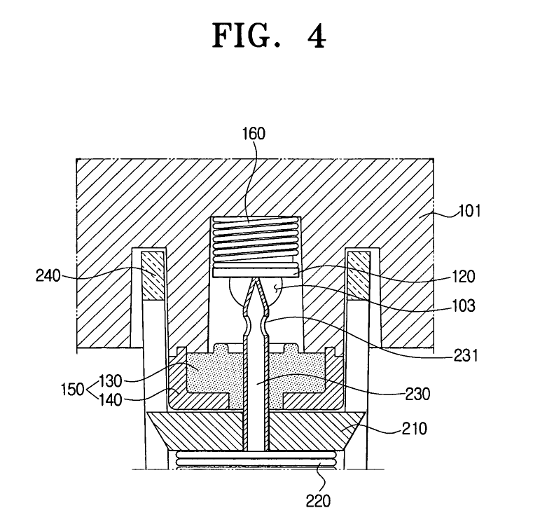

As illustrated in FIGS. 2 and 3, an ink cartridge of an image forming device (for example, an inkjet printer) includes a cartridge body 50 having an ink discharging unit 100, and an inner cap 120 movably disposed in the ink discharging unit 100. The inner cap 120 is disposed in an interior cavity 104 in the ink discharging unit 100. The inner cap 120 is positioned at a capped end of the interior cavity 104 and is movable in predetermined directions which opens (unseals or regulates flow of ink in) the ink discharging unit 100. A needle 230 of a needle assembly 200 causes the inner cap 120 to move. The needle 230 will be described with reference to FIGS. 2 and 4 as part of the needle assembly 200 that may be combined or coupled with the ink discharging unit 100.

As shown in FIG. 2, an ink tank (not illustrated) is disposed in the cartridge body 50 which contains ink. The ink discharging unit 100 is disposed on one side end of the cartridge body 50. The discharging unit 100 discharges the ink contained in the ink tank to the outside the cartridge body 50. The ink discharging unit 100 also includes a discharging unit body 110, and an outer cap 150 disposed at an end of the discharging unit body 110.

The discharging unit body 110 is formed in a pipe shape having a hollowed space (the interior cavity 104) therein, and includes an ink supplying hole 103. The ink supplying hole 103 communicates with the ink tank. In various aspects, the ink supplying hole 103 may be formed anywhere in the interior cavity 104. As shown, the ink supplying hole 103 is formed in a wall of the interior cavity 104.

An outer cap 150 includes a sealing member 130, and a cover member 140. The sealing member 130 is formed of a rubber material which makes a tight seal to prevent the ink that flows into the discharging unit body 110 from leaking. Also, the sealing member 130 has a guide groove 133, which is not yet penetrated or perforated as shown in FIG. 3. The guide groove 133 is formed on the sealing member 130 at a position corresponding to the needle 230. When the ink discharging unit 100 and the needle assembly 200 are aligned, and the needle 230 penetrates the sealing member 130, that the guide groove 133 guides the needle 230 to penetrate the sealing member 130 at a desired location, namely the center of the guide groove 133. Also, the guide groove 133 provides additional sealing surface areas for the needle 230 when the needle 230 penetrates the sealing member 130. In other aspects, the sealing member 130 may be plastic, synthetic polymers, or the like.

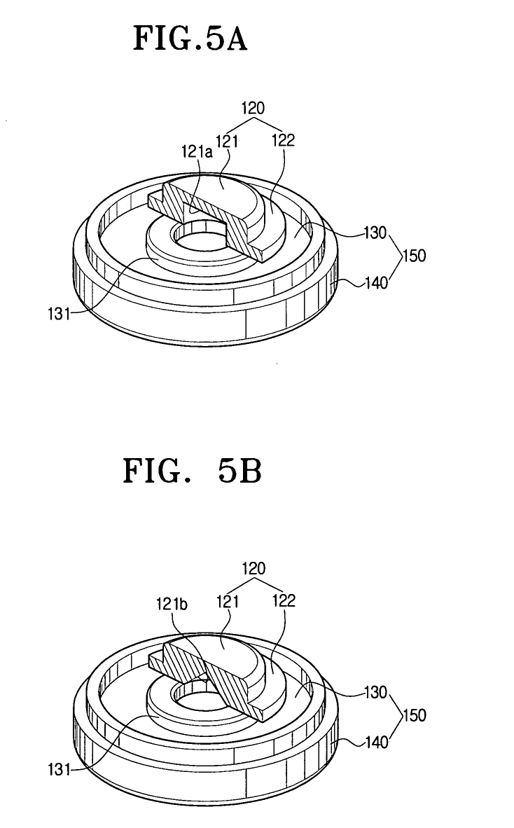

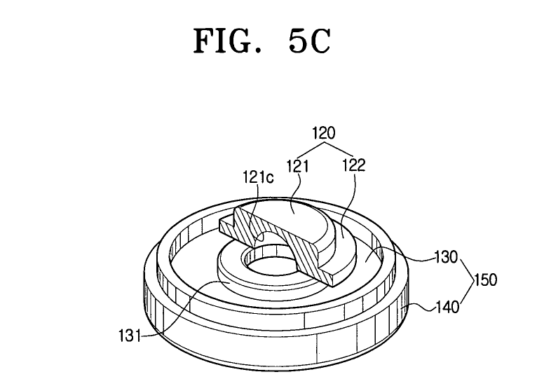

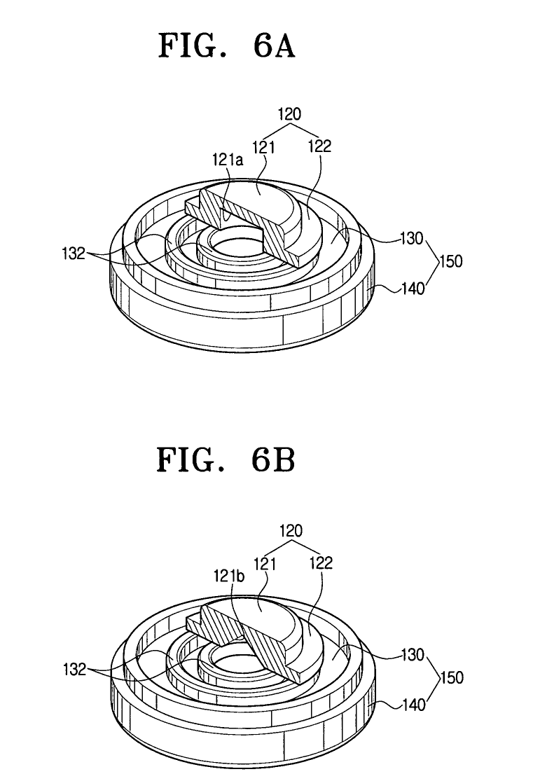

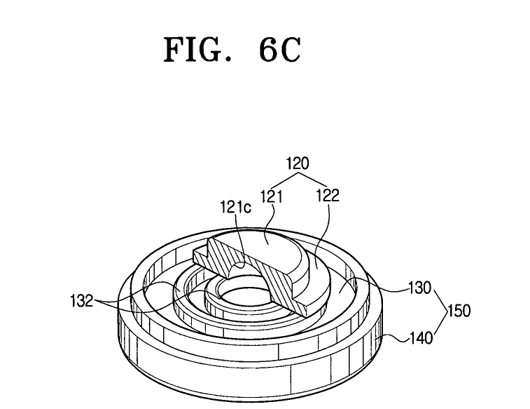

In various aspects as shown, the sealing member 130 has a seal 131 (see FIGS. 5A through 5C) or 132 (see FIG. 6A through FIG. 6C) formed on a portion thereof. Accordingly, the seal 131 or 132 comes in to contact with the inner cap 120. The seal 131 or 132 is formed in an annular shape, so that the seal 131 or 132 surrounds a penetrated (or a penetrable) hole of the sealing member 130 when the sealing member 130 is penetrated by the needle 230. In various aspects, the seal 131 or 132 may have any shape including triangular, rectangular, oval, or the like, shapes. In other aspects, the sealing member 130 may include a shaped groove instead of the protruding seal 131 or 132. The shaped groove may be annular in shape, or any other desired shape.

The seal 131 can be formed in the form of a single ring, as illustrated in FIGS. 5A through 5C. Similarly, the seal 132 can be a plurality of rings that is coaxially positioned with respect to a center of the sealing member 130, as illustrated in FIGS. 6A through 6C. Alternatively, the seal 131 or 132 can be formed on an undersurface of the inner cap 120. In one aspect, a corresponding groove or grooves may be formed on the sealing member 130 opposite the seal 131 or 132 of the inner cap 120. In this aspect, the seal 131 or 132 may be seated in the groove of the sealing member 130. In another aspect, the seal 131 or 132 may be formed to protrude on both the sealing member 130 and the inner cap 120. In this aspect, the seals that are on opposing sides of the sealing member 130 and the inner cap 120 may align end to end, or may not be aligned so that they overlap when brought together.

In the aspect shown in FIG. 3, the cover member 140 is formed over the sealing member 130. The cover member 140 is fused and attached to the discharging unit body 110 by an ultrasonic fusing process. Accordingly, the cover member 140 fixes the sealing member 130 to the discharging unit body 110. A portion of the cover member 140, which faces the guide groove 133, is opened to form an opening to allow passage of the needle 230. In various aspects, the cover member 140 need not be fused to the discharging unit body 110, but may be clamped, bonded, or otherwise attached. Additionally, the cover member 140 may be molded as a single unit with the discharging unit body 110. In various aspects, the cover member 140 may be metal, plastic, polymer, composite, or the like.

Hereinafter, the inner cap 120 will be described in details with reference to FIGS. 3 through 6C. As shown, the inner cap 120 is disposed to be movable within the discharging unit body 110 by the needle 230 and/or the cap elastic member 160 (see FIGS. 2, 3, and 4). In non-limiting aspects as shown in FIGS. 5A through 6C, the inner cap 120 is formed in the form of disc. In these aspects, the inner cap 120 includes a first cylindrical part 121 and a second cylindrical part 122. In various aspects, the inner cap 120 may be a piston or a sliding plug, which are thicker as compared to the disc.

The placement of the cap elastic member 160 on the first cylindrical part 121 is as illustrated in FIG. 3. The second cylindrical part 122 includes one of needle seating grooves (or indented seating parts) 121a, 121b, or 121c (see FIGS. 5A through 5C, or 6A through 6C) on an undersurface thereof. The needle 230 is seated in the needle seating groove 121a, 121b, or 121c. The needle seating groove 121a, 121b, or 121c may be formed in a shape corresponding to an end of the needle 230, but such is not required. In various aspects, the end of the needle 230 may be any desired shape.

An end tip of the needle 230 can be configured in various shapes. Accordingly, FIGS. 5A through 5C illustrate the shapes of the needle seating grooves 121a, 121b, and 121c that correspond to various possible end tips of the needle 230, which may be a cylinder shape, a cone shape, and a hemisphere shape, respectively. FIGS. 6A through 6C also illustrate the same shapes of the needle seating grooves 121a, 121b, and 121c as those of FIGS. 5A through 5C. However, FIGS. 6A through 6C show a sealing member 130 with the seal 132 formed in the form of a plurality of rings.

The ink cartridge as described above conveys the ink to the nozzle assembly (not illustrated) by an ink supplying apparatus. The ink supplying apparatus includes the ink discharging unit 100, the inner cap 120, and the needle assembly 200.

The ink discharging unit 100 and the inner cap 120 are the same as those described above. As shown in FIG. 4, the needle assembly 200 includes a needle guide 210, a needle elastic member 220, a needle 230, and a needle housing 240. The needle guide 210 is elastically supported in the needle housing 240 by the needle elastic member 220. The needle guide 210 can be moved by contact with the outer cap 150 of the ink discharging unit 100. The needle guide 210 is movably disposed between a first position (see FIG. 2) where the needle guide 210 surrounds the needle 230 so as not to expose the needle 230 to the outside, and a second position (see FIG. 4) where the needle guide 210 exposes the needle 230 when the ink cartridge is mounted and secured to the needle assembly 200.

The needle 230 also has an ink supplying passage formed therein. The needle 230 penetrates the sealing member 130, and moves the inner cap 120 up and down and/or side to side, depending on the orientation, in cooperation with the cap elastic member 160. An ink supplying hole 231 is located at the vicinity of the tip end of the needle 230. The ink supplying hole 231 is formed transversely to the axis and through the wall of the needle 230. The ink supplying hole 231 is inserted into the discharging unit body 110 to take in the ink therein. In addition, an ink supplying passage to supply the ink to a print head (not shown) is formed in the needle 230. Accordingly, the ink taken in through ink supplying hole 231 is supplied to the print head by way of the needle 230.

Next, an operation of the ink supplying apparatus of the inkjet printer in accordance with an aspect of the present invention will be described in details with reference to the drawings.

As illustrated in FIG. 2, the ink supplying apparatus of the inkjet printer includes the ink discharging unit 100, the needle assembly 200, and the inner cap 120. The ink discharging unit 100 is disposed on the one side end of the cartridge body 50, the needle assembly 200 is disposed on a head base 201 on which the print head is mounted, and the inner cap 120 is movably disposed in the ink discharging unit 100. The inner cap 120 prevents the ink from leaking when the ink discharging unit 100 and the needle assembly 200 are separated from each other.

As illustrated in FIG. 3, the end of the ink discharging unit 100 containing the inner cap 120 is kept closed (or sealed) by the outer cap 150 until a needle 230 penetrates the sealing member 130. Accordingly, the outer cap 150 keeps the ink from leaking from the ink discharging unit 100 until the ink discharging unit 100 is combined or coupled with the needle assembly 200.

As shown in FIG. 3, for example, the outer cap 150 includes the sealing member 130 of rubber material, and the cover member 140 of metal material. The center of the cover member 140 is formed to expose the sealing member 130 to the outside. The guide groove 133 is formed or otherwise cut away at or near a center of the sealing member 130 and guides the needle 230 to penetrate the sealing member 130 at an accurate position thereof.

Accordingly, when the ink discharging unit 100 and the needle assembly 200 are connected with or coupled to each other, the needle housing 240 of the needle assembly 200 is inserted into an inserting groove 102 formed on the ink discharging unit 100. At this time, the needle guide 210 is lowered to expose the needle 230. The needle guide 210 is pushed by the outer cap 150 assembled at an end tip of the ink discharging unit 100.

The exposed needle 230 penetrates the sealing member 130 of rubber material through the guide groove 133 exposed at the center of the cover member 140 while tearing or perforating the sealing member 130. The needle 230 then pushes the inner cap 120 while coming in to contact with (or being seated in) one of the needle seating grooves 121a, 121b, or 121c formed on the inner cap 120. Then, the ink is supplied from the ink supplying hole 103 into the ink discharging unit 100, and is conveyed to the print head through the needle ink supplying hole 231 and the needle 230. In various aspects, instead of the needle 230 tearing or perforating the sealing member 130, the sealing member may have a preexisting or preformed full or partial slit, hole, and/or cut to further guide the needle 230 through the sealing member 130. Such full or partial slit, hole, and/or cut may be formed in the guide groove 133.

As discussed above, when the ink cartridge is mounted on the head base 201, the needle 230 is guided through the guide groove 133 formed in the center of the sealing member 130 to penetrate the sealing member 130 and be inserted in a desired position. Accordingly, the needle 230 can be guided through the center of the sealing member 130.

Also, as discussed above, the end tip of the needle 230 is formed in the shape that corresponds to one of the needle seating grooves 121a, 121b or 121c. Accordingly, the needle 230 can move the inner cap 120 while the needle 230 is supported by the inner cap 120. More specifically, the exposed end of the needle 230 (near the ink supplying hole 231) is supported by the inner cap 120 at one of the seating grooves 121a, 121b, or 121c. The support by one of the seating grooves may be provided by a snug fit and/or by friction between the end of the needle 230 and one of the seating grooves. Because of the support by one of the seating grooves, the needle 230 may move the inner cap 120 while both the needle 230 and the inner cap 120 are positioned at any orientation, for example, even in a horizontal state. Accordingly, the bending and deforming of the needle 230 in an ink supplying apparatus is addressed or decreased even as the inner cap 120 is moved in a sloped or a horizontal state. Thus, the inner cap 120 supports one of the ends of the needle 230 by seating the end of the needle 230, and then guiding the needle 230 as the needle 230 is inserted into the ink discharging unit 100.

As described above, as the needle 230 is not deformed, the penetrated (or the penetrable) hole formed in the sealing member 130 also does not gape. Accordingly, because the sealing member comes in to close contact with the needle 230 and also makes a tight seal with the needle 230, external air does not flow in through the penetrated (or the penetrable) hole during the printing operation of an image forming device.

On the other hand, when the ink cartridge is separated from the head base 201 to be removed from the image forming device, the needle 230 that was inserted into the ink discharging unit 100 is removed, and the inner cap 120 that had been moved by the needle 230 is returned to an original position where the inner cap 120 contacts the sealing member 130 at the urging of the cap elastic member 160, as illustrated in FIG. 3.

In a non-limiting example, the seal 131 or 132 is made of the same rubber material as that of the sealing member 130. Also, in a non-limiting example, the seal 131 or 132 is formed in an annular shape to surround the penetrated (or the penetrable) hole of the sealing member 130 that is penetrated by the needle 230. Further, the inner cap 120 comes in to close contact with the seal 131 or 132 due to the restoring force of the cap elastic member 160 once the needle 230 is removed. As a result, an ink leakage thorough the penetrated (or the penetrable) hole can be prevented. It should be understood that in other aspects, the material for the seal 131 or 132, and the material for the sealing member 130 may be different.

As is apparent from the foregoing description, according to various aspects of the present invention, the ink cartridge and the ink supplying apparatus of the image forming device can not only consistently maintain the inserting position of the needle, but can also securely move the inner cap when the ink cartridge is mounted, to thereby prevent the needle from being deformed. Once the needle is not deformed, the penetrated (or the penetrable) hole formed as the needle penetrates the sealing member does not gape, but forms a close (or tight) seal with the needle. Accordingly, during a printing operation, the inflow of external air into the ink cartridge through the gap in the penetrated (or the penetrable) hole can be prevented.

Also, according to aspects of the present invention, the ink cartridge and the ink supplying apparatus of the image forming device is configured, so that when the needle is removed, the inner cap comes in to close contact with the seal formed on the sealing member to close up the penetrated (or the penetrable) hole. Accordingly, the leakage of ink thorough the penetrated (or the penetrable) hole can be prevented.

Although a few aspects of the present invention have been shown and described, it would be appreciated by those skilled in the art that changes may be made in the aspects departing from the principles and spirit of the invention, the scope of which is defined in the claims and their equivalents.

What is claimed is:

1. An ink cartridge, comprising:
a cartridge body having an ink discharging unit; and
an inner cap having a needle seating groove formed in a predetermined shape corresponding to an end of a needle to be inserted into the ink discharging unit, the inner cap being disposed in the ink discharging unit to selectively seal the ink discharging unit, and the inner cap being movable in a direction which selectively unseals the ink discharging unit by the needle.

2. The ink cartridge of claim 1, further comprising an outer cap disposed on the outside of the ink discharging unit.

3. The ink cartridge of claim 1, further comprising an elastic member to elastically urge the inner cap in a direction which selectively seals the ink discharging unit.

4. The ink cartridge of claim 1, wherein the inner cap is disc shaped.

5. The ink cartridge of claim 2, wherein the outer cap is penetrated by the needle.

6. The ink cartridge of claim 5, wherein the outer cap comprises:
a sealing member through which the needle penetrates; and
a cover member to attach the sealing member to the ink discharging unit.

7. The ink cartridge of claim 6, wherein the sealing member has a guide groove to guide an inserting position of the needle.

8. The ink cartridge of claim 6, further comprising at least one seal to form a seal between the inner cap and the sealing member.

9. The ink cartridge of claim 8, wherein the at least one seal is formed on the sealing member.

10. The ink cartridge of claim 8, wherein the at least one seal is formed on the inner cap.

11. The ink cartridge of claim 9, wherein the sealing member includes a penetrable hole, and the at least one seal is formed in an annular shape so that the at least one seal surrounds the penetrable hole of the sealing member when the needle is inserted into the penetrable hole.

12. The ink cartridge of claim 10, wherein the sealing member includes a penetrable hole and the at least one seal is formed in an annular shape so that the seal surrounds the penetrable hole of the sealing member when the needle is inserted into the penetrable hole.

13. The ink cartridge of claim 11, wherein the at least one seal comprises a plurality of seals.

14. An ink supplying apparatus to supply ink from an ink cartridge, comprising:
an ink discharging unit to discharge ink from the ink cartridge;
an inner cap disposed in the ink discharging unit to selectively seal the ink discharging unit; and
a needle assembly comprising a needle connectable to the ink discharging unit, the needle able to move the inner cap in a direction which selectively unseals the ink discharging unit so that the needle forms an ink supplying passage,
wherein the inner cap comprises a needle seating groove formed at a position contacting the needle and formed in a shape that corresponds to an end of the needle.

15. The ink supplying apparatus of claim 14, wherein the inner cap is movable between a first position which selectively seals the ink discharging unit, and a second position which selectively unseals the ink discharging unit, and the apparatus further comprises an elastic member to elastically urge the inner cap to the first position.

16. The ink supplying apparatus of claim 14, further comprising an outer cap attached to the outside of the ink discharging unit, and the outer cap comprising an inserting position guide groove which is initially not penetrated and which is formed at a position where the outer cap is to be penetrated by the needle.

17. The ink supplying apparatus of claim 15, further comprising an outer cap attached to the outside of the ink discharging unit, and the outer cap comprising an inserting position guide groove, which is initially not penetrated and which is formed at a position where the outer cap is to be penetrated by the needle.

18. The ink supplying apparatus of claim 17, wherein the outer cap comprises:
a sealing member through which the needle is inserted; and
a cover member to attach the sealing member to the ink discharging unit.

19. The ink supplying apparatus of claim 18, further comprising at least one seal to form a seal between the inner cap and the sealing member.

20. The ink supplying apparatus of claim 19, wherein the at least one seal is formed on at least one of the sealing member and the inner cap.

21. The ink supplying apparatus of claim 20, wherein the sealing member includes a penetrable hole, and the at least one seal is formed in an annular shape, so that the seal surrounds a penetrable hole of the sealing member when the needle is inserted into the penetrable hole.

22. The ink supplying apparatus of claim 21, wherein the at least one seal comprises a plurality of seals.

23. An ink discharging part, comprising:
an internal cavity formed in the ink discharging unit to receive ink, the internal cavity being capped at one end; and
an inner cap slidingly positioned inside the internal cavity, the inner cap comprising an indented seating part to receive a needle, and to guide and support the needle as the inner cap slides along the internal cavity.

24. The ink discharging part of claim 23, further comprising an elastic member positioned behind the inner cap to urge the inner cap towards the capped end of the internal cavity.

25. The ink discharging part of claim 23, further comprising a sealing member to cap the capped end of the internal cavity.

26. The ink discharging part of claim 25, wherein the sealing member comprises at least one seal formed on one surface of the sealing member that faces the inner cap.

27. The ink discharging part of 25, wherein the sealing member comprises a guide groove formed on one surface of the sealing member that does not face the inner cap.

28. The ink discharging part of claim 25, wherein the sealing member comprises a hole formed by the needle, and the formed hole forms a close seal with the needle.

29. An ink supplying apparatus, comprising:
the ink discharging part of claim 23; and
the needle in communication with a printer head, wherein when the ink discharging part and the needle are coupled, the needle is received by the indented seating part, then guided and supported as the inner cap slides along the internal cavity.

30. The ink discharging part of claim 23, wherein the indented seating part has a shape that corresponds to a shape of a received end of the needle.
